(19) United States
(12) Patent Application Publication
(10) Pub. No.: US 2026/0320745 A1
(43) Pub. Date: Oct. 15, 2026

(54) SELFIE INTEGRATION SYSTEM FOR MOBILE PHOTOGRAPHY

(71) Applicant: SAMSUNG ELECTRONICS CO., LTD., Suwon-si (KR)

(72) Inventors: Evgeny ARTYOMOV, Tel-Aviv (IL); Ishay GOLDIN, Tel-Aviv (IL); Gil SHAPIRA, Tel-Aviv (IL); Niv ZEHNGUT, Tel-Aviv (IL)

(73) Assignee: SAMSUNG ELECTRONICS CO., LTD., Suwon-si (KR)

(21) Appl. No.: 19/174,638

(22) Filed: Apr. 9, 2025

(51) Int. Cl. G06T 5/50; G06T 5/60; G06V 20/00; H04N 23/57; H04N 23/63

(52) U.S. Cl. CPC G06T 5/50; G06T 5/60; G06V 20/36; G06V 20/39; H04N 23/57; H04N 23/631; G06T 2207/20084; G06T 2207/20221; G06T 2207/30196

(57) ABSTRACT

An electronic device for generating a combined image, including: a first camera; a second camera; at least one processor configured to implement at least one artificial intelligence (AI) model; and a memory configured to store instructions which, when executed by the at least one processor, cause the electronic device to: obtain a first input image captured using the first camera, obtain a second input image captured using the second camera, detect, using the at least one AI model, a user of the electronic device in the second input image, generate, using the at least one AI model, a user image including the user, generate, using the at least one AI model, a preview image based on the first input image, wherein the preview image includes a portion of the first input image and a placement proposal indicator that is disposed at a proposed position within the preview image, and generate, using the at least one AI model, the combined image based on the preview image, wherein the combined image includes the portion of the first input image, and the user image disposed at the proposed position.

### 1. FIELD

The present disclosure relates to image processing, and more particularly to generating a combined image that includes an image of a scene and an image of a user.

### 2. DESCRIPTION OF RELATED ART

Smartphone cameras have revolutionized personal photography. However, obtaining an image which includes the captured scene as well as the user who captured the image remains challenging, especially in situations involving group photographs or solo photographs.

Some approaches for obtaining such an image may involve timers, selfie sticks, or relying on others. However, these approaches may have limitations in quality, convenience, and composition. Front-facing cameras may partially address this issue, but often lack context and quality compared to rear-facing cameras.

Other approaches may involve artificial intelligence (AI), for example to generate or combine images. However, while some of these solutions show promise, they have not been fully applied to solve the self-inclusion problem in real-time mobile photography.

### SUMMARY

Provided are systems, methods, and devices for generating a combined image that includes an image of a scene and an image of a user.

Additional aspects will be set forth in part in the description which follows and, in part, will be apparent from the description, or may be learned by practice of the presented embodiments.

In accordance with an aspect of the disclosure, an electronic device for generating a combined image includes: a first camera; a second camera; at least one processor configured to implement at least one artificial intelligence (AI) model; and a memory configured to store instructions which, when executed by the at least one processor, cause the electronic device to: obtain a first input image captured using the first camera, obtain a second input image captured using the second camera, detect, using the at least one AI model, a user of the electronic device in the second input image, generate, using the at least one AI model, a user image including the user, generate, using the at least one AI model, a preview image based on the first input image, wherein the preview image includes a portion of the first input image and a placement proposal indicator that is disposed at a proposed position within the preview image, and generate, using the at least one AI model, the combined image based on the preview image, wherein the combined image includes the portion of the first input image, and the user image disposed at the proposed position.

In accordance with an aspect of the disclosure, a method of generating a combined image is executed by at least one processor of an electronic device and includes: obtaining a first input image captured using a first camera included in the electronic device; obtaining a second input image captured using a second camera included in the electronic device; detecting, using at least one artificial intelligence (AI) model, a user of the electronic device in the second input image; generating, using the at least one AI model, a user image including the user; generating, using the at least one AI model, a preview image based on the first input image, wherein the preview image includes a portion of the first input image and a placement proposal indicator that is disposed at a proposed position within the preview image; and generating, using the at least one AI model, the combined image based on the preview image, wherein the combined image includes the portion of the first input image, and the user image disposed at the proposed position.

In accordance with an aspect of the disclosure, a non-transitory computer-readable medium is configured to store instructions which, when executed by at least one processor of an electronic device for generating a combined image, cause the electronic device to: obtain a first input image captured using a first camera included in the electronic device; obtain a second input image captured using a second camera included in the electronic device; detect, using at least one artificial intelligence (AI) model, a user of the electronic device in the second input image; generate, using the at least one AI model, a user image including the user; generate, using the at least one AI model, a preview image based on the first input image, wherein the preview image includes a portion of the first input image and a placement proposal indicator that is disposed at a proposed position within the preview image; and generate, using the at least one AI model, the combined image based on the preview image, wherein the combined image includes the portion of the first input image, and the user image disposed at the proposed position.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a system for performing image processing, according to embodiments;

FIG. 2 is a block diagram of an electronic device including the image processing system of FIG. 1, according to embodiments;

FIG. 3 is a diagram showing an example of input images and a combined image, according to embodiments;

FIG. 4 is a diagram showing an example of a first input image and a combined image, according to embodiments;

FIG. 5 is a diagram showing an example of a first input image and a combined image, according to embodiments;

FIGS. 6 and 7 are block diagrams showing examples of combined image modules, according to embodiments;

FIG. 8 is a diagram showing an example of input images, a preview image, and a combined image, according to embodiments;

FIG. 9 is a diagram showing an example of a preview image including a placement proposal indicator, according to embodiments;

FIG. 10 is a diagram showing an example of a preview image including a plurality of placement proposal indicators, according to embodiments;

FIG. 11 is a diagram showing an example of a plurality of preview images including a plurality of placement proposal indicators, according to embodiments;

FIGS. 12A and 12B are diagrams showing an example of input images, a preview image, and a combined image, according to embodiments;

FIG. 13 is a diagram showing an example of a preview image and a combined image in which object completion is performed, according to embodiments;

FIG. 14 is a diagram showing an example of a second input image and a combined image including a plurality of user images, according to embodiments;

FIG. 15 is a flowchart of an example process for generating a combined image, according to embodiments.

### DETAILED DESCRIPTION

As discussed above, obtaining an image which includes the captured scene as well as the user acting as a photographer remains challenging, especially in situations involving group photographs or solo photographs.

Some approaches for obtaining such an image may involve timers, selfie sticks, or relying on others. However, these approaches may have limitations in quality, convenience, and composition. Front-facing cameras may partially address this issue, but often lack context and quality compared to rear-facing cameras.

Other approaches may involve artificial intelligence (AI), for example to generate or combine images. However, while some of these solutions show promise, they have not been fully applied to solve the self-inclusion problem in real-time mobile photography.

Accordingly, embodiments of the present disclosure are directed to techniques for seamlessly combining the benefits of front camera and rear camera images. For example, embodiments may use AI to create natural, high-quality images that effortlessly include the photographer in the captured scene.

For example, embodiments may allow an electronic device to simultaneously, or nearly simultaneously, capture images from two different cameras, for example a front-facing camera included in the electronic device and a rear-facing camera included in the electronic device. In addition, embodiments may use generative AI to seamlessly integrate an image of a user captured using the front-facing camera into a scene included in an image captured by the rear-facing camera.

Accordingly, embodiments may provide dual-camera capture of images, AI-powered user integration, intelligent completion of the image of the user, pose generation in an automatic, semi-automatic, or manual manner, scale and lighting adjustment, and intelligent placement of the user within the scene.

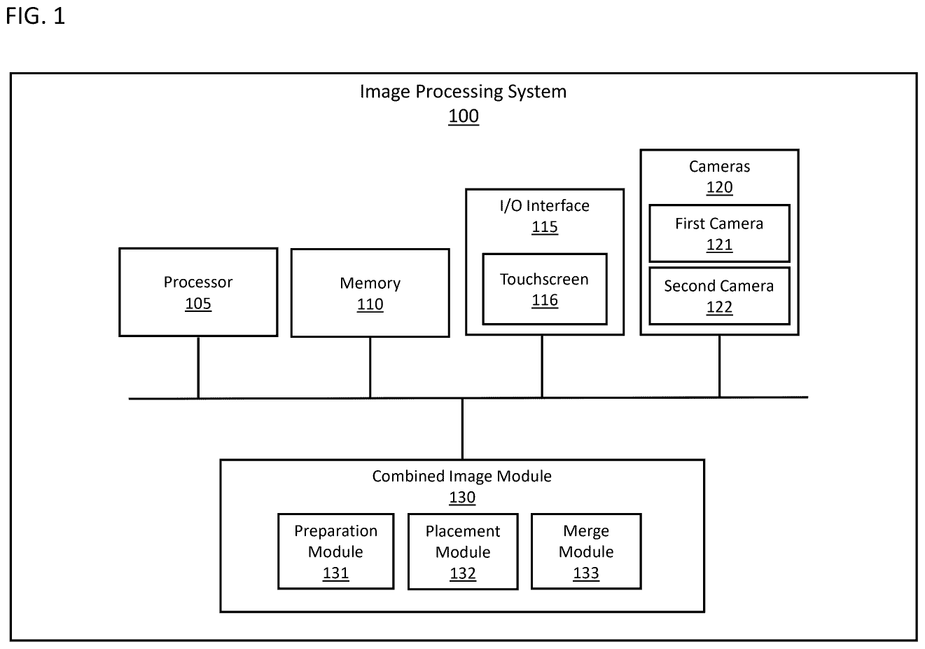

FIG. 1 is a block diagram of a system for performing image processing, according to embodiments. As shown in FIG. 1, the image processing system 100 may include a processor 105, a memory 110, an input/output (I/O) interface 115, one or more cameras 120, and a combined image module 130.

The processor 105 may be, or may include, an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In embodiments, the processor 105 may configured to operate a memory array using a memory controller. For example, a memory controller may be integrated into the processor 105. In embodiments, the processor 105 may be configured to execute computer-readable instructions stored in a memory to perform various functions. However, embodiments are not limited thereto, and the memory controller may be included in any other element of the image processing system 100, for example in the memory 110.

The memory 110 (e.g., a memory device) may include at least one of a random access memory (RAM), a read-only memory (ROM), and a hard disk. For example, the memory 110 may include solid state memory and a hard disk drive. The memory 110 may be used to store computer-readable and computer-executable software including instructions which, when executed, may cause the processor 105 to perform various functions described herein. For example, the memory 110 may include, among other things, a basic input/output system (BIOS) which may control basic hardware or software operation such as the interaction with peripheral components or devices. In some cases, memory cells within a memory 110 store information in as a logical state of the memory cells.

The I/O interface 115 may manage signals which are input from and output to the image processing system 100 and the elements included therein. The I/O interface 115 may also manage peripherals which not integrated into a device. For example, the I/O interface 115 may represent a physical connection or port to an external peripheral. In embodiments, the I/O interface 115 may utilize an operating system such as iOS®, ANDROID®, MS-DOS®, MS-WINDOWS®, OS/2®, UNIX®, LINUX®, or another operating system. In embodiments, the I/O interface 115 may represent or interact with a modem, a keyboard, a mouse, or a similar device. In embodiments, the I/O interface may include a touchscreen 116, which may be used to display images and receive touch inputs from a user. In embodiments, the I/O interface 115 may be implemented as part of a processor 105. In embodiments, a user may interact with a device using the I/O interface 115 or using hardware components controlled by the I/O interface 115.

The image processing system 100 may include an optical instrument (e.g., the one or more cameras 120, an image sensor, etc.) for recording or capturing images, which may be stored locally, transmitted to another location, etc. For example, the cameras 120 may capture visual information using one or more photosensitive elements that may be tuned for sensitivity to a visible spectrum of electromagnetic radiation. A resolution of the visual information may be measured in pixels, where each pixel may relate an independent piece of captured information. In embodiments, each pixel may correspond to one component of, for example, a two-dimensional (2D) Fourier transform of an image. Computation methods may use pixel information to reconstruct images captured by the device. In the camera 120, one or more image sensors may convert light incident on a lens of the camera 120 into an analog or digital signal. The image processing system 100 may then display an image on a display panel (e.g., the touchscreen 116) based on the digital signal. In embodiments, the one or more cameras may include, for example, a first camera 121 and a second camera 122.

A pixel (e.g., a pixel sensor) may store information about received electromagnetic radiation (e.g., light). Each pixel may include one or more photodiodes and one or more complementary metal oxide semiconductor (CMOS) transistors. A photodiode may receive a light and may output charges. The amount of output charges may be proportional to the amount of light received by the photodiode. CMOS transistors may output a voltage based on charges output from the photodiode. A level of a voltage output from the photodiode may be proportional to the amount of charges output from the photodiode. For example, the level of the voltage output from a photodiode may be proportional to the amount of light received by the photodiode.

The combined image module 130 may include a preparation module 131, a placement module 132, and a merge module 133. For example, in some embodiments the combined image module 130 may receive a first input image captured by the first camera 121, which may be for example an image of a scene, and a second input image captured by the second camera, which may be for example an image including a user of the image processing system 100, and may output a combined image that may be generated based on the first input image and the second input image. In embodiments, one or more of the preparation module 131, the placement module 132, and the merge module 133 may be a machine learning, artificial intelligence, and/or neural network model, but embodiments are not limited thereto.

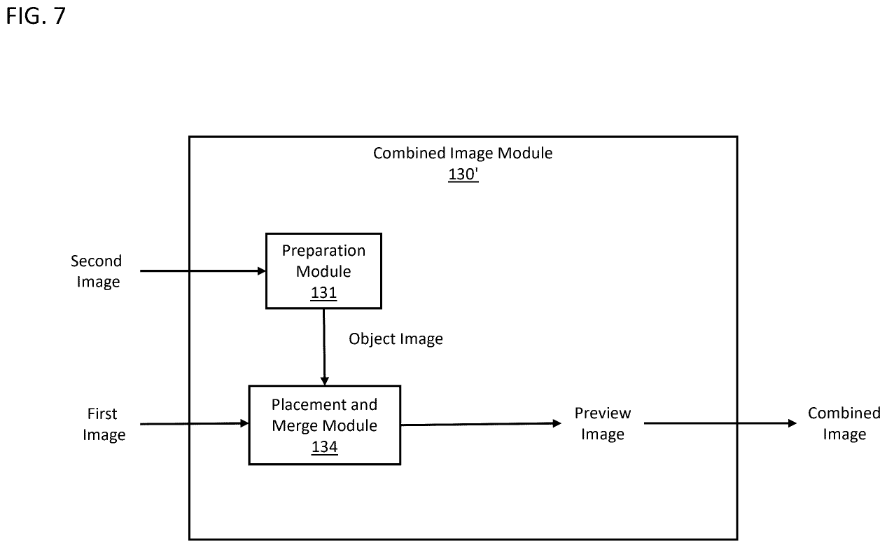

Although examples are described herein in which the combined image module 130 is a separate component included in the image processing system 100 including the preparation module 131, the placement module 132, and the merge module 133, embodiments are not limited thereto. For example, in some embodiments, the combined image module 130 and/or the components included therein may be implemented by another component of the image processing system 100, for example the processor 105. As another example, one or more of the components included in the combined image module 130 may be directly included in the image processing system 100, or included in another component of the image processing system. As yet another example, one or more of the preparation module 131, the placement module 132, and the merge module 133, or other elements which may perform the functions thereof, may be split into multiple components, or combined into a single component, an example of which is described below with reference to FIG. 7.

According to embodiments, one or more of the image processing system 100, the processor 105, and the combined image module 130 may be used to implement a training module configured to train machine learning, artificial intelligence, and/or neural network architectures included in the image processing system 100, for example one or more of the components included in the combined image module 130. In embodiments, the image processing system 100 may implement image processing networks to perform specialized tasks. For example, at least one of machine learning, artificial intelligence, and neural network processing may be implanted for various imaging and computer vision applications. A neural network may refer to a type of computer algorithm that is capable of learning specific patterns without being explicitly programmed, but through iterations over known data. A neural network may refer to a cognitive model that includes input nodes, hidden nodes, and output nodes. Nodes in the network may have an activation function that computes whether the node is activated based on the output of previous nodes. Training the system may involve supplying values for the inputs, and modifying edge weights and activation functions (algorithmically or randomly) until the result closely approximates a set of desired outputs.

An artificial neural network (ANN) may refer to a hardware or a software component that includes a number of connected nodes (i.e., artificial neurons), which may loosely correspond to the neurons in a human brain. Each connection, or edge, may transmit a signal from one node to another (similar to the physical synapses in a brain). When a node receives a signal, the node may process the signal and then transmit the processed signal to other connected nodes. In embodiments, the signals between nodes may include real numbers, and the output of each node may be computed by a function of the sum of its inputs. In embodiments, the nodes may determine their outputs using other mathematical algorithms (e.g., selecting the max from the inputs as the output) or any other suitable algorithm for activating the node. Each node and edge may be associated with one or more node weights which may be used to determine how the signal is processed and transmitted.

During a training process, these weights may be adjusted, for example by the training module, to improve the accuracy of the result (i.e., by minimizing a loss function which corresponds in some way to the difference between the current result and the target result). The weight of an edge increases or decreases the strength of the signal transmitted between nodes. In embodiments, nodes may have a threshold below which a signal is not transmitted at all. In some embodiments, the nodes may be aggregated into layers, and different layers may perform different transformations on their inputs. The initial layer may be referred to as the input layer, and the last layer is known as the output layer. In some embodiments, signals may traverse certain layers multiple times.

A convolutional neural network (CNN) may refer to a class of neural networks that may be used in computer vision or image classification systems. In embodiments, a CNN may enable processing of digital images with minimal pre-processing. A CNN may be characterized by the use of convolutional (or cross-correlational) hidden layers. These layers may apply a convolution operation to the input before signaling the result to the next layer. Each convolutional node may process data for a limited field of input, which may be referred to as the receptive field. During a forward pass of the CNN, filters at each layer may be convolved across the input volume, computing the dot product between the filter and the input. During the training process, the filters may be modified so that they activate when they detect a particular feature within the input. In embodiments, one or more of the components included in the combined image module 130, for example preparation module 131, the placement module 132, and the merge module 133 may be, or may include, one or more image processing networks, for example one or more ANNs, CNNs, etc., which may be trained using the training module. In addition, one or more of the components included in the combined image module 130 may be a generative AI model which may be trained to generate at least a portion of an image. For example, the generative AI model may include one or more of a transformer model, a generative adversarial network (GAN), a variational auto-encoder (VAE), a diffusion model, an autoregressive model, a flow-based model, or any other type of model, and may be trained using the training module.

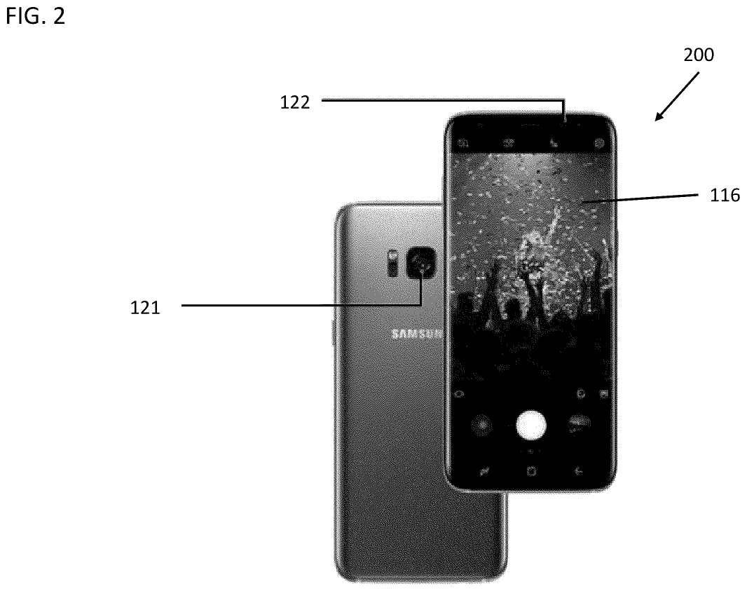

FIG. 2 is a block diagram of an electronic device including the image processing system of FIG. 1. In some embodiments, the electronic device 200 may be a mobile device such as a smartphone, but embodiments are not limited thereto. For example, according to embodiments, the electronic device 200 may be, or may include, a personal computer, a laptop computer, a tablet computer, a personal digital assistant, or any other type of electronic device. In embodiments, the electronic device 200 may include, or may be used to implement, the image processing system 100 and/or one or more of the components included therein, for example the combined image module 130 and the components included therein.

As shown in FIG. 2, the electronic device 200 may include the first camera 121, the second camera 122, and the touchscreen 116. In embodiments, the first camera 121 may be referred to as a main camera of the electronic device 200, and the second camera may 122 may be referred to as at least one of a secondary camera, an alternative camera, and a “selfie” camera of the electronic device 200, but embodiments are not limited thereto. For example, according to embodiments, the first camera 121 may be a rear-facing camera included in the electronic device 200, and the second camera 122 may be a front-facing camera included in the electronic device 200.

The electronic device 200 may use the touchscreen 116 to display images such as one or more of the first input image captured by the first camera 121, the second input image captured by the second camera 122, the combined image, and any other image described herein with reference to FIGS. 1-15. In addition, the electronic device 200 may use the touchscreen 116 to display one or more user interfaces and to receive one or more user inputs.

As discussed above, embodiments may provide an innovative approach to mobile photography, which may seamlessly merge the content of front-facing cameras (e.g., the second camera 122) and rear-facing cameras (e.g., the first camera 121) using advanced artificial intelligence. Embodiments may capture images from both cameras and utilize at least one AI model (e.g., one or more components included in the combined image module 130) to integrate an image of the user captured using one camera into an image of a scene captured using the other camera into a combined image. By using the image of the user as a reference, the at least one AI model may generate or complete any missing portions of the user, adjust pose and lighting for natural integration, and automatically, semi-automatically, or manually select an optimal placement within the scene. Accordingly, embodiments may allow users to effortlessly include themselves in the image of the scene. Accordingly, embodiments may provide a more inclusive photography experience, which may be particularly beneficial for group photographs, solo travelers, and capturing images of oneself in memorable locations and situations.

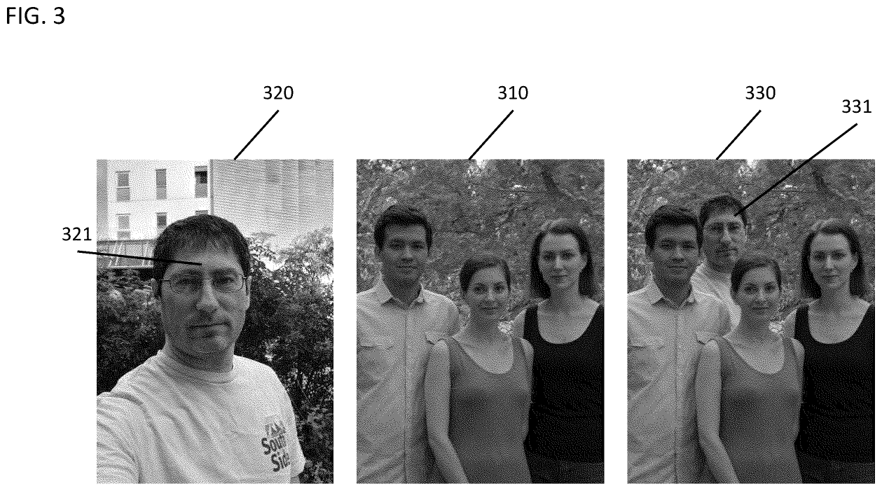

FIG. 3 is a diagram showing an example of input images and a combined image, according to embodiments. For example, as shown in FIG. 3, the first camera 121 may capture a first input image 310 of a scene, and the second camera 122 may capture a second input image 320 of a user of the electronic device 200. The preparation module 131 may detect the user in a portion 321 of the second input image 320, and may generate a user image 331 based on the portion 321. Then the placement module 132 may select a placement position for the user image, and the merge module may generate a combined image including a portion of the first input image 310, and also including the user image 331, which may be placed at the placement position selected by the placement module 132.

Although examples are described herein in which an image of the user is detected in the second input image, a user image is generated based on the portion, and a combined image is generated which includes user image, embodiments are not limited thereto. For example, according to embodiments, any other object may be detected in the portion of the second input image, and embodiments may include generating an object image based on the portion, and generating the combined image based on the object image. As another example, in some embodiments the second input image may include another person who is not a user of the electronic device, and embodiments may include generating a person image based on the portion, and generating the combined image based on the person image.

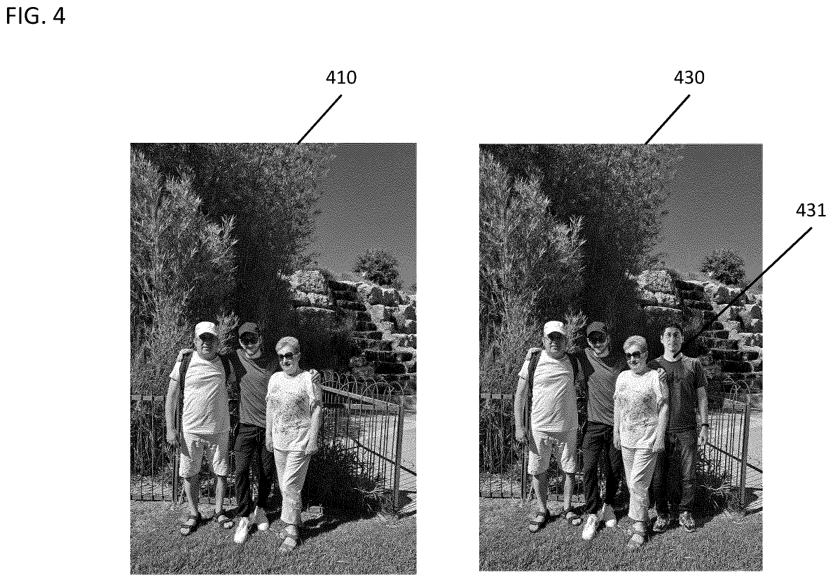

FIG. 4 is a diagram showing an example of a first input image and a combined image, according to embodiments. For example, as shown in FIG. 4, the first camera 121 may capture a first input image 410 of a scene, and the combined image module 130 may generate a combined image 430 including a portion of the first input image 410, and also including a user image 431, which may be generated based on a second input image captured by the second camera 122.

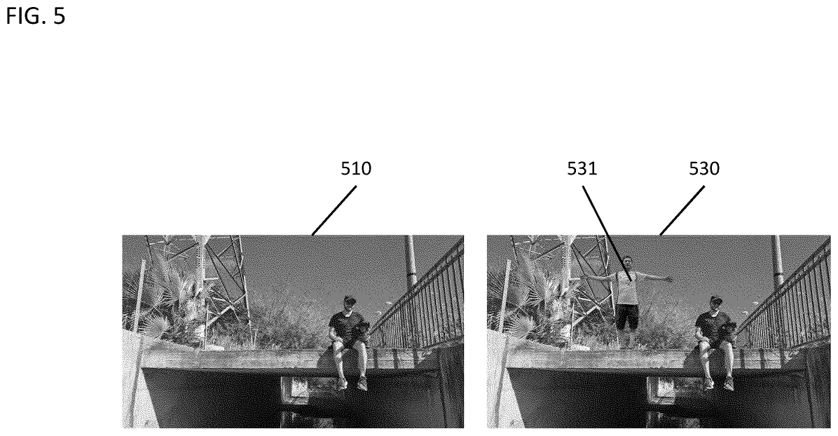

FIG. 5 is a diagram showing an example of a first input image and a combined image, according to embodiments. For example, as shown in FIG. 4, the first camera 121 may capture a first input image 510 of a scene, and the combined image module 130 may generate a combined image 530 including a portion of the first input image 510, and also including a user image 531, which may be generated based on a second input image captured by the second camera 122.

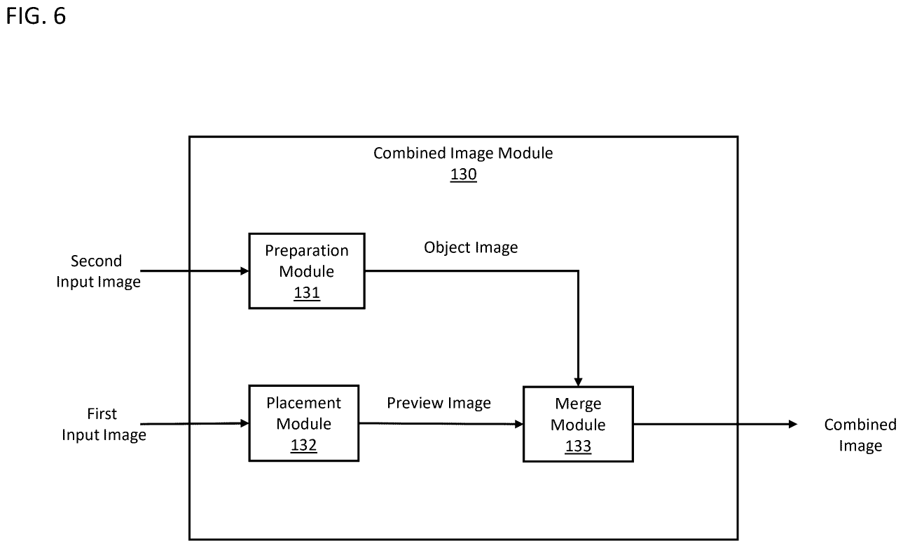

FIG. 6 is a block diagram showing an example of a combined image module, according to embodiments. As shown in FIG. 6, the combined image module 130 may include the preparation module 131, the placement module 132, and the merge module 133.

The preparation module 131 may detect a user included in the second input image, and may generate a user image which may be added to the first input image to create a combined image. For example, the user image may be an image which includes the user (e.g., a portion of the second input image which includes the user). In embodiments, the portion of the second input image including the user may be incomplete, and the preparation module 131 may generate a reconstructed image corresponding to missing portions of the user, which may also be included in the user image. In embodiments, the reconstructed image may be generated based on, for example, other images of the user, which may be taken previously and stored in the electronic device 200, but embodiments are not limited thereto. In addition, in some embodiments, the preparation module 131 may use an image that is previously stored instead of the second input image, but embodiments are not limited thereto.

The placement module 132 may analyze the first input image and the second input image, and may select a proposed location at which the user image may be added to the first input image. In some embodiments, the placement module 132 may generate a preview image, which may also be referred to as a proposed image. The preview image may include a portion of the first input image, and may further include a placement proposal indicator which may indicate the proposed position for the user image to be added. In some embodiments, the placement module 132 may select a plurality of proposed positions, and may generate one or more preview images including a plurality of placement proposal indicators indicating the plurality of proposed positions.

In some embodiments, the first input image and the second input image may be included in image streams and/or videos captured by the first camera 121 and the second camera 122. Accordingly, the combined image module 130 may generate new preview images as new first input images and new second input images are captured, and the preview images may be displayed on the touchscreen 116 in real time, or approximately real time.

According to embodiments, the electronic device 200 and/or the image processing system 100 may display the one or more preview images to the user, and may receive a user input selecting or approving at least one preview images and the placement proposal indicators, for example using the touchscreen 116. Based on at least one of the preview images and the placement proposal indicators being selected or approved, for example according to a user input, the merge module 133 may then generate a combined image which may include the portion of the first input image, and may also include the user image located or disposed at the proposed position that was selected or approved. However, embodiments are not limited thereto, and in some embodiments the combined image may be generated automatically without user input.

FIG. 7 is a block diagram showing another example of a combined image module, according to embodiments. As shown in FIG. 7, the combined image module 130′ may include the preparation module 131 and a placement and merge module 134, which may correspond to a combination of the placement module 132 and the merge module 133. Some of the components included in the combined image module 130′ may be similar to elements discussed above, and therefore redundant or duplicative description may be omitted for convenience.

In embodiments, the placement and merge module 134 may obtain the user image generated by the preparation module 131, and may generate the combined image without first generating a preview image including the placement proposal indicators. In some embodiments, the electronic device may display the combined image as a preview image, for example using the touchscreen 116, and may either store or discard the combined image according to a user input.

According to embodiments, because the combined image module 130′ may generate multiple combined images, the operation of the combined image module 130′ may be more computationally intensive than the operation of the combined image module 130, but embodiments are not limited thereto.

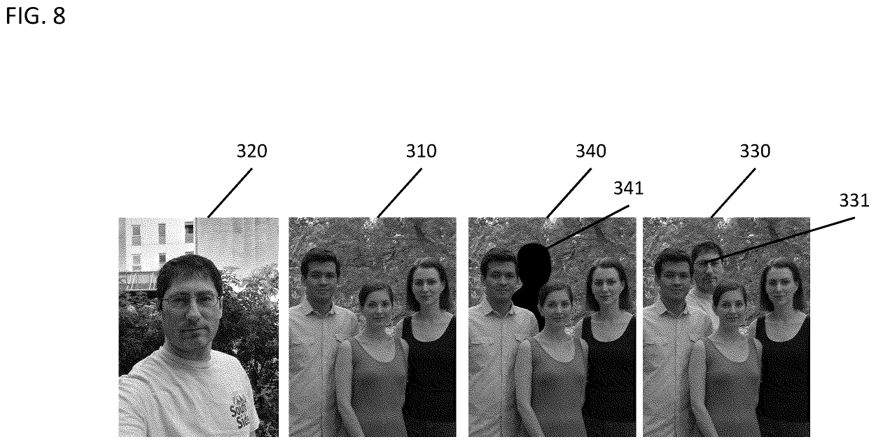

FIG. 8 is a diagram showing an example of input images, a preview image, and a combined image, according to embodiments. As discussed above, the combined image module 130 may automatically generate proposed positions for integrating the user into the scene, or the user can select the position manually. These positions can be visually indicated to the user using the placement proposal indicators discussed above. For example, according to embodiments, the placement proposal indicators may be, or may include, a shadow figure corresponding to the user, a stick figure corresponding to the user, or any other proxy representation that may be used to indicate the user. In embodiments, the proposed positions may be selected in consideration of one or more objects included in the scene of the first input image. For example, the placement positions may be selected so that the user image is integrated into the arrangement of the plurality of objects included in the scene, and appears to be a natural or appropriate part of the scene.

For example, as shown in FIG. 8, the placement module 132 may generate a preview image 340 based on the first input image 310 and the second input image 320 discussed above. The preview image 340 may include a placement proposal indicator 341, which may be placed a proposed position selected by the placement module 132. As shown in FIG. 8, the placement proposal indicator 341 may be a shadow figure that may have a shape that is similar to the user image 331, and may be used by the user to consider how the combined image 330 may appear, before it is generated. In some embodiments, the placement proposal indicator 341 may be generated by the placement module 132 based on the user image 331 generated by the preparation module 131, but embodiments are not limited thereto. According to embodiments, based on at least one of the preview image 340 and the placement proposal indicator 341 being selected or approved, for example according to a user input, the merge module 133 may proceed to generate the combined image 330.

According to embodiments, multiple options (e.g. multiple preview images and/or multiple placement proposal indicators) may also be presented, allowing the user to select their preferred placement, providing a clear visual guidance for person integration locations. When presenting real-time preview images based on a video stream, the combined image module 130 may not attempt to generate the full combined image in real time (e.g., at 30 frames per second or any other frame rate), because doing so may be computationally intensive and often unnecessary. Instead, these simplified representations allow for efficient, real-time interaction while preserving resources for the generation of the final combined image. When generating full combined images in real time, embodiments may adapt the framerate of the generation to the computer resources available, and generate at lower frame rate if required.

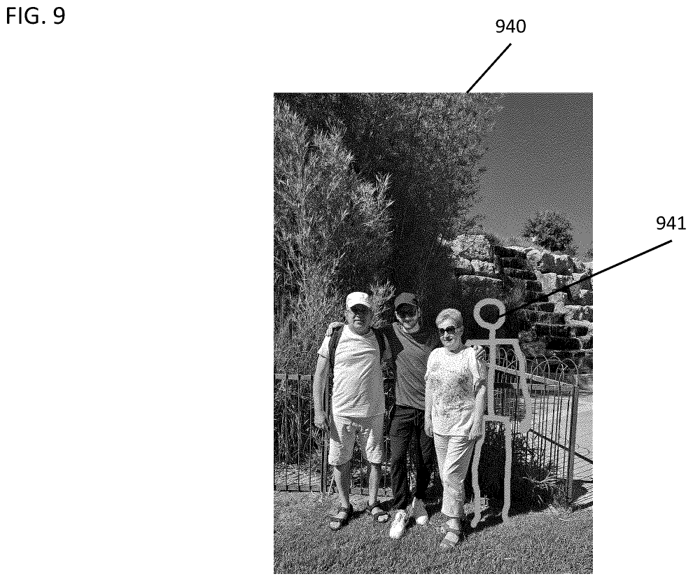

FIG. 9 is a diagram showing an example of a preview image including a placement proposal indicator, according to embodiments. As shown in FIG. 9, a preview image 940 may include a placement proposal indicator 941, which may for example be a stick figure. In embodiments, the stick figure may be useful when the user image is an image of the user or another human.

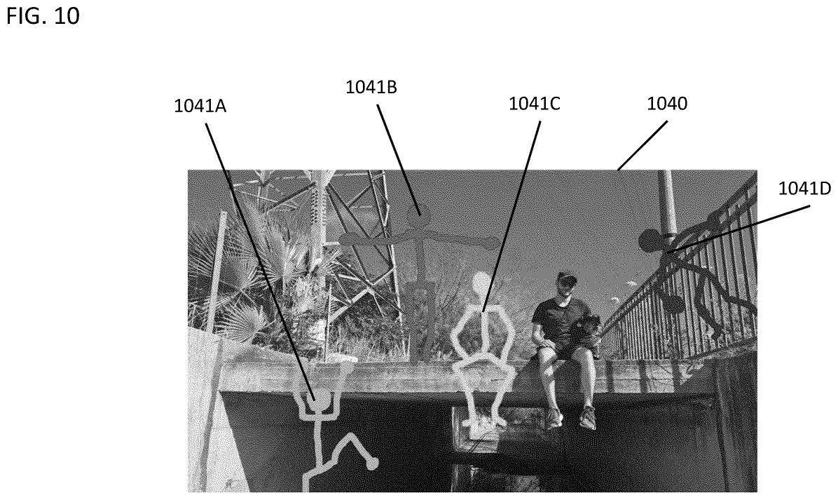

FIG. 10 is a diagram showing an example of a preview image including a plurality of placement proposal indicators, according to embodiments. As shown in FIG. 10, a single preview image 1040 may include a plurality of placement proposal indicators, for example a first placement proposal indicator 1041A, a second placement proposal indicator 1041B, a third placement proposal indicator 1041C, and a fourth placement proposal indicator 1041D. The plurality of placement proposal indicators may be placed at different proposed positions, to provide the user with multiple options for generating the combined image. For example, the user may select the desired placement proposal indicator by providing a user input, for example using the touchscreen 116 or any other input method such as voice input.

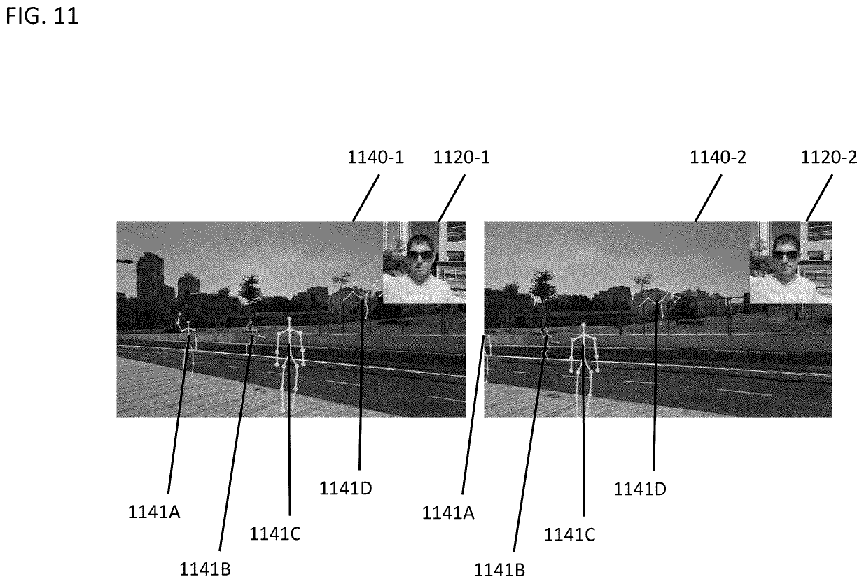

FIG. 11 is a diagram showing an example of a plurality of preview images including a plurality of placement proposal indicators, according to embodiments. As shown in FIG. 11, the combined image module 130 may generate a preview image 1140-1 at a first time point in a video stream corresponding to a second input image 1120-1, and another preview image 1140-2 at a second time point in the video stream corresponding to a second input image 1120-2. Both of the preview image 1140-1 and the preview image 1140-2 may include a plurality of placement proposal indicators, for example a first placement proposal indicator 1141A, a second placement proposal indicator 1141B, a third placement proposal indicator 1141C, and a fourth placement proposal indicator 1141D. According to embodiments, the placement proposal indicators may be anchored to specific locations, and may stay in place regardless of camera movement.

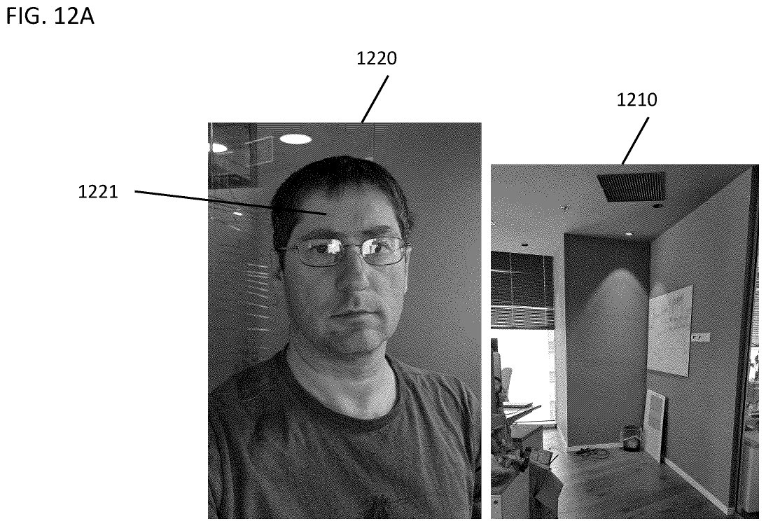

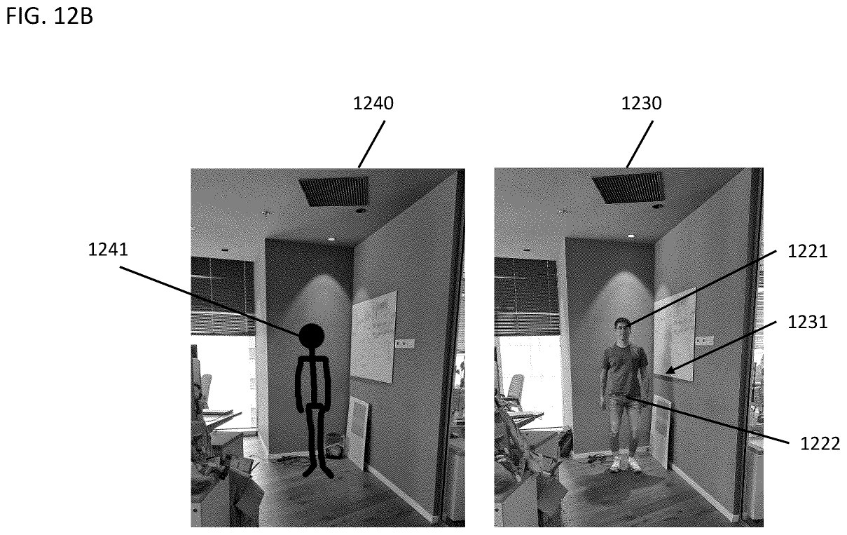

FIGS. 12A and 12B are diagrams showing an example of input images, a preview image, and a combined image, according to embodiments. According to embodiments, if any portions of the user are missing, the preparation module 131 may intelligently complete the user image by generating a restored user image including the missing portions of the user. For example, using generative AI algorithms, the preparation module 131 may analyze the available data included in the portion of the second input image corresponding to the user, and may use contextual information from the first input image to synthesize the missing portion.

According to embodiments, the preparation module 131 may generate a restored user image include missing portions of the user's body, and may therefore generate the user image as a full-body representation of the user. This process may involve predicting and generating anatomically correct body parts, such as lower limbs or obscured areas, that are consistent with the visible portions of the user. The preparation module 131 may consider factors such as body proportions, pose estimation, and clothing style to ensure a natural and cohesive appearance. Additionally, the preparation module 131 may consider the context of the first input image, including the activity or setting, to generate appropriate body positioning and attire. This seamless completion may allow for more flexible selfie capture, as users need not worry about including their entire body in the second input image, thus enabling more spontaneous and diverse self-portraits integrated into wider scenes.

For example, as shown in FIG. 12A, a user may capture a second input image 1220 which is to be combined with a first input image 1210. The placement module 132 may generate a preview image 1240 including a placement proposal indicator 1241 which may be a stick figure corresponding to a full-body representation of the user. However, some portions of the user's body may be missing from a portion 1221 of the second input image 1220 corresponding to the user. Therefore, if the preview image 1240 and/or the placement proposal indicator 1241 is approved or selected, the preparation module 131 may generate a reconstructed image 1222 corresponding to the missing portions, and may generate a user image 1231 including the portion 1221 and the reconstructed image 1222. Accordingly, the merge module 133 may generate a combined image 1230 which includes a full-body representation of the user.

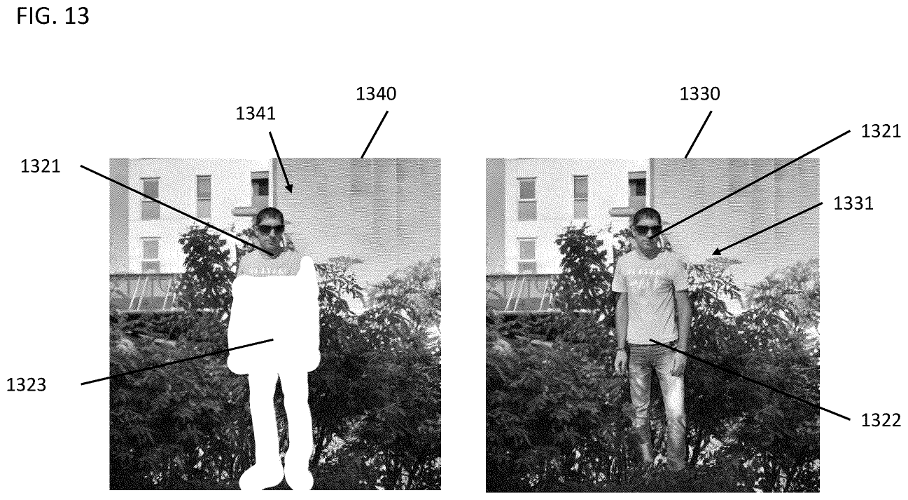

FIG. 13 is a diagram showing an example of a preview image and a combined image in which object completion is performed, according to embodiments. For example, as shown in FIG. 13, the placement module 132 may generate a preview image 1340 including a placement proposal indicator 1341 which includes a portion 1321 of a second input image, and a blank space corresponding to the missing portion 1323 of the user (e.g., the object). Then, if the preview image 1340 and/or the placement proposal indicator 1341 is approved or selected, the preparation module 131 may generate a reconstructed image 1322 corresponding to the missing portions, and may generate a user image 1331 including the portion 1321 and the reconstructed image 1322. Accordingly, the merge module 133 may generate a combined image 1330 which includes a full-body representation of the user.

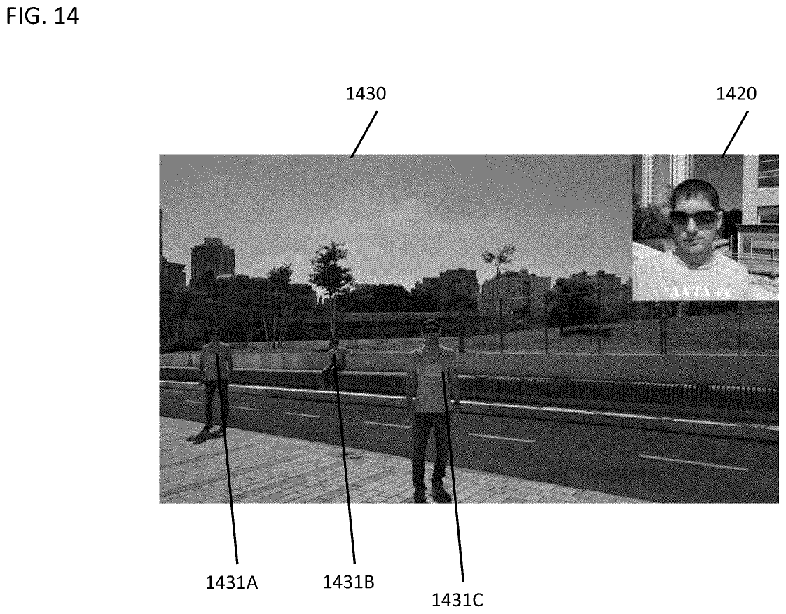

FIG. 14 is a diagram showing an example of a second input image and a combined image including a plurality of user images, according to embodiments. As shown in FIG. 14, the combined image module 130 may generate a combined image 1430 which includes a plurality of user images, for example a first user image 1431A, a second user image 1431B, and a third user image 1431C. In embodiments, all or some of the plurality of user images may be generated based on the same second input image 1420, but embodiments are not limited thereto.

In some embodiments, the electronic device 200 may incorporate a user control interface that may allow for personalized adjustments and fine-tuning of the image combination process. For example, the user control interface may operate based on touchscreen controls which may be received using the touchscreen 116. For example, these controls may allow a user to interact with the touchscreen 116 to make precise adjustments. According to embodiments, these controls may include at least one of manually choosing the placement position, fine-tuning the placement (e.g., by dragging the user image to the desired placement position), scaling the combined image, and selecting from multiple preview images and/or placement proposal indicators, and choosing desired facial expressions from a predetermined menu (e.g., smile, serious, surprised) which may allow the user's face included in the user image to be modified.

As another example, the user control interface may operate based on voice controls, which may allow hands-free control over various aspects of the image combination process. According to embodiments, these controls may include at least one of positioning of the user image e.g., using voice commands such as “Move me to the left,” “Place me in the background”), selection of preferred clothing style (e.g., using voice commands such as “Change my outfit to casual,” “Put me in formal wear”), pose adjustments (“Make me stand,” “Show me sitting”), selecting combination parameters (e.g., using voice commands such as “Increase contrast,” “Match lighting to the scene”), and selecting facial expressions (e.g., using voice commands such as “Make me smile,” “Change my expression to thoughtful”).

According to embodiments, the electronic device 200 may also allow any combination of touchscreen controls, voice controls, and another type of controls. These user control options may ensure that while the image processing system may automate the complex tasks of image capture, analysis, and combination, the user may retain creative control over the final composition.

As discussed above, in some embodiments the image processing system 100 may also utilize previously captured images (e.g., from a gallery stored in the image processing system 100 and/or the electronic device 200) as a prior for generation of the user image. These images may allow the image processing system 100 to overcome the limited field of view of the cameras and capture the full appearance of the user. Another possible option is that the user may take a selfie image and then subsequently capture a main photo with rear camera (e.g., not simultaneously. Accordingly, the image processing system 100 may allow a different user experience, so that the user may first capture a satisfactory image of the user, and then focus on capturing a desirable image to be combined.

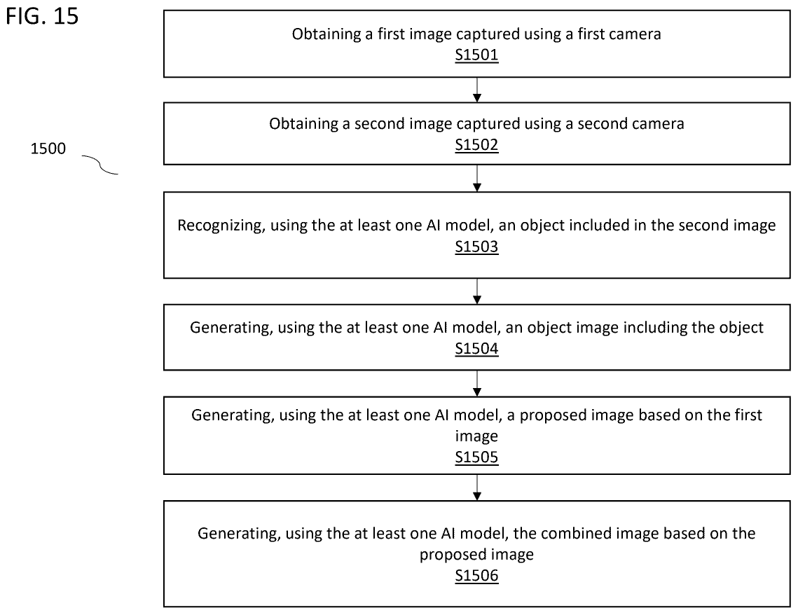

FIG. 15 is a flowchart of an example process for generating a combined image, according to embodiments. In some implementations, one or more process blocks of FIG. 15 may be performed by any of the elements discussed above, for example one or more of the image processing system 100, the electronic device 200, and any of the components included therein, such as the combined image module 130, the preparation module 131, the placement module 132, and the merge module 133.

As shown in FIG. 15, at operation S1501 the process 1500 may include obtaining a first input image captured using a first camera. In embodiments, the first camera may correspond to the first camera 121 discussed above.

As further shown in FIG. 15, at operation S1502 the process 1500 may include obtaining a second input image captured using a second camera. In embodiments, the second camera may correspond to the second camera 122 discussed above. In embodiments, both the first camera and the second camera may be included in single electronic device, for example the electronic device 200 discussed above. In embodiments, the first image and the second image may be captured simultaneously, or nearly simultaneously.

As further shown in FIG. 15, at operation S1502 the process 1500 may include detecting, using at least one AI model, a user of the electronic device in the second input image. In embodiments, the at least one AI model may correspond to at least one of the combined image module 130 and the components included therein, for example the preparation module 131.

As further shown in FIG. 15, at operation S1502 the process 1500 may include generating, using the at least one AI model, a user image including the user. In embodiments, the at least one AI model may correspond to at least one of the combined image module 130 and the components included therein, for example the preparation module 131.

As further shown in FIG. 15, at operation S1502 the process 1500 may include generating, using the at least one AI model, a preview image based on the first input image. In embodiments, the preview image may include a portion of the first input image and a placement proposal indicator that is located or disposed at a proposed position within the preview image. In embodiments, the at least one AI model may correspond to at least one of the combined image module 130 and the components included therein, for example the placement module 132.

As further shown in FIG. 15, at operation S1502 the process 1500 may include generating, using the at least one AI model, the combined image based on the preview image. In embodiments, the combined image may include the portion of the first input image, and may also include the user image located or disposed at the proposed position. In embodiments, the at least one AI model may correspond to at least one of the combined image module 130 and the components included therein, for example the merge module 133.

In embodiments, the first camera may be located at a first side of the electronic device, and the second camera may be located at a second side of the electronic device that is opposite to the first side.

In embodiments, the first side may be a rear side of the electronic device, the second side may be a front side of the electronic device, and the electronic device may include a touchscreen located on the second side of the electronic device, and the first input image and the second input image are captured based on at least one user input received from the user using the touchscreen.

In embodiments, the first input image and the second input image are captured based on at least one voice input received from the user.

In embodiments, the generating of the user image may include: extracting a portion of the second input image corresponding to the user; and generating, using the at least one AI model, a reconstructed image corresponding to a missing portion of the user that is missing from the portion of the second input image, and the user image may include the portion of the second input image and the reconstructed image.

In embodiments, the reconstructed image may be generated based on at least one stored image of the user that was previously stored on the electronic device.

In embodiments, the first input image may include at least one object, and the proposed position may be determined based on the at least one object.

In embodiments, the placement proposal indicator may include a proxy figure corresponding to the user.

In embodiments, the preview image may be included in a plurality of preview images, the plurality of preview images may include a plurality of placement proposal indicators located at different proposed positions within the plurality of preview images, and the combined image may be generated based on receiving a user input selecting the preview image from among the plurality of preview images.

Although FIG. 15 shows example blocks of the process 1500, in some implementations, the process 1500 may include additional blocks, fewer blocks, different blocks, or differently arranged blocks than those depicted in the process 1500. Additionally, or alternatively, two or more of the blocks of the process 1500 may be arranged or combined in any order, or performed in parallel.

Accordingly, embodiments may provide an innovative approach to mobile photography, which may seamlessly merge images and/or videos captured using front-facing cameras (e.g., the second camera 122) and rear-facing cameras (e.g., the first camera 121) using advanced artificial intelligence. Embodiments may capture images from both cameras and utilize at least one AI model (e.g., one or more components included in the combined image module 130) to integrate an image of the user captured using one camera into an image of a scene captured using the other camera into a combined image. In some embodiments, these images may be supplemented by pre-stored images. By using the image of the user as a reference, the at least one AI model may generate or complete any missing portions of the user, adjust pose and lighting for natural integration, and automatically, semi-automatically, or manually select an placement within the scene. Accordingly, embodiments may allow users to effortlessly include themselves in the image of the scene, and may enable users to be part of the images they capture without the need for a another user to operate the camera or the use of a timer, which may result in more inclusive and spontaneous photography experiences.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The various operations of methods described above may be performed by any suitable means capable of performing the operations, such as various hardware and/or software component(s), circuits, and/or module(s).

The software may include an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing is illustrative of certain embodiments and is not to be construed as limiting thereof. Although a few embodiments have been described, those skilled in the art will readily appreciate that many modifications are possible in the embodiments without materially departing from the present scope.

What is claimed is:

1. An electronic device for generating a combined image, the electronic device comprising:
a first camera;
a second camera;
at least one processor configured to implement at least one artificial intelligence (AI) model; and
a memory configured to store instructions which, when executed by the at least one processor, cause the electronic device to:
obtain a first input image captured using the first camera,
obtain a second input image captured using the second camera,
detect, using the at least one AI model, a user of the electronic device in the second input image,
generate, using the at least one AI model, a user image including the user,
generate, using the at least one AI model, a preview image based on the first input image, wherein the preview image comprises a portion of the first input image and a placement proposal indicator that is disposed at a proposed position within the preview image, and
generate, using the at least one AI model, the combined image based on the preview image, wherein the combined image comprises the portion of the first input image, and the user image disposed at the proposed position.

2. The electronic device of claim 1, wherein the first camera is disposed on a first side of the electronic device, and
wherein the second camera is disposed on a second side of the electronic device that is opposite to the first side.

3. The electronic device of claim 2, wherein the first side is a rear side of the electronic device,
wherein the second side is a front side of the electronic device,
wherein the electronic device further comprises a touchscreen disposed on the second side of the electronic device, and
wherein the first input image and the second input image are captured based on at least one user input received from the user using the touchscreen.

4. The electronic device of claim 1, wherein to generate the user image, the instructions further cause the electronic device to:
extract a portion of the second input image corresponding to the user; and
generate, using the at least one AI model, a reconstructed image corresponding to a missing portion of the user that is missing from the portion of the second input image,
wherein the user image comprises the portion of the second input image and the reconstructed image.

5. The electronic device of claim 4, wherein the reconstructed image is generated based on at least one stored image of the user that was previously stored on the electronic device.

6. The electronic device of claim 1, wherein the first input image comprises at least one object, and
wherein the proposed position is determined based on the at least one object.

7. The electronic device of claim 1, wherein the placement proposal indicator comprises a proxy figure corresponding to the user.

8. The electronic device of claim 7, wherein the preview image is included in a plurality of preview images,
wherein the plurality of preview images comprise a plurality of placement proposal indicators at different proposed positions within the plurality of preview images, and
wherein the combined image is generated based on receiving a user input selecting the preview image from among the plurality of preview images.

9. The electronic device of claim 8, wherein the user input comprises a voice input received from the user.

10. A method of generating a combined image, the method being executed by at least one processor of an electronic device and comprising:
obtaining a first input image captured using a first camera included in the electronic device;
obtaining a second input image captured using a second camera included in the electronic device;
detecting, using at least one artificial intelligence (AI) model, a user of the electronic device in the second input image;
generating, using the at least one AI model, a user image including the user;
generating, using the at least one AI model, a preview image based on the first input image, wherein the preview image comprises a portion of the first input image and a placement proposal indicator that is disposed at a proposed position within the preview image; and
generating, using the at least one AI model, the combined image based on the preview image, wherein the combined image comprises the portion of the first input image, and the user image disposed at the proposed position.

11. The method of claim 10, wherein the first camera is disposed on a first side of the electronic device, and
wherein the second camera is disposed on a second side of the electronic device that is opposite to the first side.

12. The method of claim 11, wherein the first side is a rear side of the electronic device,
wherein the second side is a front side of the electronic device,
wherein the electronic device comprises a touchscreen disposed on the second side of the electronic device, and
wherein the first input image and the second input image are captured based on at least one user input received from the user using the touchscreen.

13. The method of claim 10, wherein the generating of the user image comprises:
extracting a portion of the second input image corresponding to the user; and
generating, using the at least one AI model, a reconstructed image corresponding to a missing portion of the user that is missing from the portion of the second input image,
wherein the user image comprises the portion of the second input image and the reconstructed image.

14. The method of claim 13, wherein the reconstructed image is generated based on at least one stored image of the user that was previously stored on the electronic device.

15. The method of claim 10, wherein the first input image comprises at least one object, and
wherein the proposed position is determined based on the at least one object.

16. The method of claim 10, wherein the placement proposal indicator comprises a proxy figure corresponding to the user.

17. The method of claim 16, wherein the preview image is included in a plurality of preview images,
wherein the plurality of preview images comprise a plurality of placement proposal indicators at different proposed positions within the plurality of preview images, and
wherein the combined image is generated based on receiving a user input selecting the preview image from among the plurality of preview images.

18. The method of claim 17, wherein the user input comprises a voice input received from the user.

19. A non-transitory computer-readable medium configured to store instructions which, when executed by at least one processor of an electronic device for generating a combined image, cause the electronic device to:
obtain a first input image captured using a first camera included in the electronic device;
obtain a second input image captured using a second camera included in the electronic device;
detect, using at least one artificial intelligence (AI) model, a user of the electronic device in the second input image;
generate, using the at least one AI model, a user image including the user;
generate, using the at least one AI model, a preview image based on the first input image, wherein the preview image comprises a portion of the first input image and a placement proposal indicator that is disposed at a proposed position within the preview image; and
generate, using the at least one AI model, the combined image based on the preview image, wherein the combined image comprises the portion of the first input image, and the user image disposed at the proposed position.

20. The electronic device of claim 1, wherein to generate the user image, the instructions further cause the electronic device to:
extract a portion of the second input image corresponding to the user; and
generate, using the at least one AI model, a reconstructed image corresponding to a missing portion of the user that is missing from the portion of the second input image,
wherein the user image comprises the portion of the second input image and the reconstructed image.
